(19) United States
(12) Patent Application Publication
(10) Pub. No.: US 2002/0174977 A1
(43) Pub. Date: Nov. 28, 2002

(54) Apparatus and method for condensing liquid solvent

(76) Inventors: Robert E. Low, Northwich (GB); Stuart Corr, Warrington (GB); James David Morrison, Northwich (GB); Frederick Thomas Murphy, Frodsham (GB)

Correspondence Address: Andrew G. Kolomayets, Cook, Alex, McFarron, Manzo,, Cummings & Mehler, Ltd., 200 West Adams Street - #2850, Chicago, IL, 60606, US

(21) Appl. No.: 10/083,898

(22) Filed: Feb. 27, 2002

Related U.S. Application Data
(63) Continuation of application No. PCT/GB00/03351, filed on Sep. 1, 2000.

(30) Foreign Application Priority Data
Sep. 6, 1999 (GB) 9920951.2

(51) Int. Cl. F28D 7/10

(52) U.S. Cl. 165/157

(57) ABSTRACT

A condenser (20) includes within its shell (22) a reservoir (22b) for condensed solvent used in biomass extraction. The reservoir (22b) supplies liquid solvent (23) to an extraction vessel (11) via an inverted lute (30). The height of the uppermost part (35) of the lute (30) determines the level of liquid (28) in the reservoir. In an embodiment the height of the uppermost part (35) is adjustable, to control the liquid level.

### CROSS REFERENCE TO RELATED APPLICATION

This application is a continuation of pending International Application No. PCT/GB00/03351, filed Sep. 1, 2000 and published in English.

This invention concerns apparatuses and a method for condensing liquid solvent following “extraction” of biomass. Biomass extraction is the extraction of flavours, fragrances or pharmaceutically active ingredients from materials of natural origin (these materials being referred to as “biomass” in the body of this text).

### BACKGROUND OF THE INVENTION

Examples of biomass materials include but are not limited to flavoursome or aromatic substances such as coriander, cloves, star anise, coffee, orange juice, fennel seeds, cumin, ginger and other kinds of bark, leaves, flowers, fruit, roots, rhizomes and seeds. Biomass may also be extracted in the form of biologically active substances such as pesticides and pharmaceutically active substances or precursors thereto, obtainable, e.g., from plant material, a cell culture or a fermentation broth.

There is growing technical and commercial interest in using near-critical solvents in such extraction processes. Examples of such solvents include liquefied carbon dioxide or, of particular interest, a family of chlorine-free solvents based on organic hydrofluorocarbon (“HFC”) species.

Preferred hydrofluorocarbons are the hydrofluoroalkanes and particularly the C₁₋₄hydrofluoroalkanes. Suitable examples of C₁₋₄hydrofluoroalkanes which maybe used as solvents include, inter alia, trifluoromethane (R-23), fluoromethane (R-41), difluoromethane (R-32), pentafluoroethane (R-125), 1,1,1-trifluoroethane (R-143a), 1,1,2,2-tetrafluoroethane (R-134), 1,1,1,2-tetrafluoroethane (R-134a), 1,1-difluoroethane (R-152a), heptafluoropropanes and particularly 1,1,1,2,3,3,3-heptafluoropropane (R-227ea), 1,1,1,2,3,3-hexafluoropropane (R-236ea), 1,1,1,2,2,3-hexafluoropropane (R-236cb), 1,1,1,3,3,3-hexafluoropropane (R-236fa), 1,1,1,3,3-pentafluoropropane (R-245fa), 1,1,2,2,3-pentafluoropropane (R-245ca), 1,1,1,2,3-pentafluoropropane (R-245eb), 1,1,2,3,3-pentafluoropropane (R-245ea) and 1,1,1,3,3-pentafluorobutane (R-365mfc). Mixtures of two or more hydrofluorocarbons may be used if desired.

R-134a, R-227ea, R-32, R-125, R-245ca and R245fa are preferred with R-134a being especially preferred.

It is possible to carry out biomass extraction using other solvents such as chlorofluorocarbons (“CFC's”) and hydrochlorofluorocarbons (“HCHC's”), and/or mixtures of solvents.

Known extraction processes using these solvents are normally carried out in closed-loop extraction equipment. A typical example 10 of such a system is shown schematically in FIG. 1.

In this typical system, liquefied solvent is allowed to percolate by gravity in downflow through a bed of biomass held in vessel 11. Thence it flows to evaporator 12 where the volatile solvent vapour is vaporised by heat exchange with a hot fluid. The vapour from evaporator 12 is then compressed by compressor 13. The compressed vapour is next fed to a condenser 14 where it is liquefied by heat exchange with a cold fluid. The liquefied solvent is then optionally collected in intermediate storage vessel 15 or returned directly to the extraction vessel 11 via line 16 to complete the circuit.

A feature of this process is that the principal driving force for circulation of solvent through the biomass and around the system is the difference in pressure between the condenser/storage vessel and the evaporator. This difference in pressure is generated by the compressor. Thus to increase the solvent circulation rate through the biomass it is necessary to increase this pressure difference, requiring a larger and more powerful compressor.

The large difference in solvent liquid and vapour densities means that a modest increase in liquid circulation rate can require significant additional capital and operating cost. This is because any vapour volumetric flow increase requires an increase in compressor size. This means that the system designer has to compromise between the rate at which liquid can be made to flow through the biomass and the rate at which vapour can be compressed.

This invention addresses the design of suitable equipment for effecting solvent condensation and intermediate storage steps, (steps 14 and 15 in the above process block diagram).

The distribution of solvent inventory in a closed-loop extraction system plays an important part in determining the ease with which the extraction process can be controlled. In a system of the general type shown in FIG. 1, if the extractor 11 is run as a flooded bed and the condenser 13 drains to an intermediate receiver space (which could be the bottom part of the shell of the condenser), then the amount of liquid held in the receiver dictates the liquid level in the evaporator 12.

The level in the receiver and evaporator are thus inter-related—an increase in one implies a decrease in the other, because the total mass of solvent in the system is fixed during any extraction. If the evaporator is configured as a boiling pool, then a drop in its level will result in a reduction in the evaporation pressure and vapour density and subsequently a drop in the mass flow through the compressor. This will eventually lead to a reduction of the condensation rate because the condenser pressure will drop. Hence there will occur (after a time lag) a reduction in the rate at which liquid is flowing to the receiver. If no other means of driving fluid around the system (e.g., a solvent liquid pump) is present in the system, then this means that the rate at which solvent flows from the receiver to the evaporator will continue to fall for some time, because the fall in condenser pressure reduces the driving force for flow around the loop. Eventually the rate of condensation will drop below the rate of evaporation and the system pressures will recover—but this process will take time. If the oscillation is sufficiently great then the extractor could be starved of liquid or the evaporator could be flooded, with subsequent potential of liquid ingress to the compressor.

This means that, if a disturbance is introduced to the system which causes an upset in either the liquid flow into the evaporator or the vapour flow into the condenser, there is potential for this disturbance to propagate around the system and cause a nuisance.

Manual control of such a system can therefore be expected to be difficult and demanding of constant attention. Automatic control using level measurement and an electronic analogue or computer-based digital control system will be a possible option but this requires a greater degree of equipment sophistication than may be desirable for some operators. This is particularly true when the closed-loop apparatus is embodied as a “room sized” plant intended to fit into a small warehouse or other small industrial building.

There is another problem which the simple condenser/receiver arrangement of the FIG. 1 process fails to address: that of regulating the temperature of solvent entering the extractor bed. It is known that the temperature at which an extraction is carried out can affect the extraction rate and also the quality of extract obtained. It is highly desirable therefore for the plant operator to be able to control this temperature, as most extraction equipment will be required to operate on a wide range of biomass materials to give maximum occupacity (and hence profitability) of the equipment.

Also, for efficient operation of the extraction circuit, it is desirable to maintain a finite difference in pressure between the condenser and solvent evaporator, with the condenser pressure the higher of the two. This provides a driving force for circulation of the solvent and also avoids operating the compressor with too low a delivery head. If the compressor delivery pressure approaches the suction pressure too closely it is possible to overload the motor drive (because the motor has no force to work against and over-runs), which would cause the motor protective system to shut down the compressor unit.

### BRIEF SUMMARY OF THE INVENTION

According to a first aspect of the invention there is provided apparatus for a closed loop biomass extraction circuit. The apparatus comprises a substantially closed vessel having a hollow interior including an upper portion and a lower portion. The hollow interior has secured therein one or more cooling members for condensing solvent in vapour form, supplied to the hollow interior from an extractor of a biomass extraction circuit. The lower portion of the hollow interior is a reservoir for condensed solvent which may be at or below at least one of said cooling members, the reservoir including a liquid offtake for condensed solvent.

Further, preferred features of the apparatus are described and claimed in International Application No. PCT/GB00/03351, filed Sep. 1, 2000, which is incorporated herein by reference, and are listed below. One or more of the following preferred features listed below may be combined with the above and embodied in: (1) an apparatus in accordance with the first aspect described above wherein the offtake includes a pipe including an in-line lute; (2) an apparatus according to embodiment (1) above including a siphon breaking line fluidically interconnecting the uppermost part of the lute and the upper portion of the hollow interior of the vessel; (3) an apparatus according to embodiment (2) above wherein the siphon breaking line includes a resistance to flow; (4) an apparatus according to any of the embodiments (1), (2), (3) above wherein the lute includes one or more vertically extending pipe portions of a diameter large enough to permit vapour bubbles contained in liquid flowing through the lute to rise in the lute and disengage therefrom; (5) an apparatus according to embodiment (4) above wherein the lute includes an outlet pipe portion, connectable to a biomass extraction vessel or a solvent circulation pump and connected to a said vertically extending pipe portion, the diameter of the outlet portion being less than the diameter of said vertically extending pipe portion, thereby ensuring that the outlet pipe portion remains full in use of the apparatus; (6) an apparatus according to any of the above wherein the liquid offtake includes a selectively operable drain for draining liquid from the reservoir; (7) an apparatus according any of the above wherein the lower portion of the hollow interior includes a bottom wall that inclines downwardly towards the liquid offtake, whereby liquid condensate in the reservoir accumulates in the vicinity of the liquid offtake; (8) an apparatus according to embodiment (1) above or any embodiment incorporating the same wherein the depth of the lute, as defined by the vertical height of the uppermost part of the inverted lute, is adjustable; (9) an apparatus according to embodiment (8) above wherein the said depth is adjustable by lengthening or shortening of one or more length adjustable, vertically extending pipes interconnecting the lowermost and uppermost parts of the inverted lute; (10) an apparatus according to embodiment (8) or (9) wherein the lowermost and uppermost parts of the lute are interconnected by a flexible pipe and/or connector to facilitate adjustment of the depth; (11) an apparatus according to any of the above wherein the vessel includes a selectively operable vapour balancing vent for venting the upper portion of the hollow interior; (12) an apparatus according to embodiment (1) above or any embodiment incorporating the same including a modulating control line, having in-line and adjustable flow control valve, the modulating control line operatively interconnecting the liquid offtake from the reservoir and the outlet of the lute; (13) an apparatus according to embodiment (12) above including a temperature detector for generating a control signal in dependence on the temperature of liquid in the reservoir, the adjustable flow control valve being adjustable in dependence on the control signal; (14) an apparatus according to embodiment (12) above including a pressure detector for generating a control signal in dependence on the pressure of liquid in the reservoir, the adjustable flow control valve being adjustable in dependence on the control signal; (15) an apparatus according to embodiment (12) above when operated in conjunction with an evaporator for evaporating solvent supplied to the vessel, the apparatus including a detector of differential pressure between the interior of the evaporator and the hollow interior of the vessel, the detector generating a control signal in dependence thereon and the adjustable flow control valve being adjustable in dependence on the control signal; (16) an apparatus according to any of the above wherein, in use, the level of liquid in the reservoir is controlled to be higher than at least part of a said cooling member, whereby the said cooling members cool liquid in the reservoir.

The invention advantageously addresses or at least ameliorates one or more of the problems outlined above by: combining the condenser and receiver into a single vessel, and optionally incorporating a luted drain on the condenser liquid outlet line. The condenser preferably is of shell and tube type, with coolant flowing on the tube side and solvent vapour condensing on the shell side. The shell is sized so that there is a reservoir volume below the tube bundle, which acts as the liquid receiver. Preferably the unit is arranged to have a natural slope in the base with the liquid offtake advantageously located on the bottom of the shell at the low point. This makes draining down the unit at the end of an extraction a straightforward operation.

The liquid offtake pipe preferably is fitted with an inverted lute (a “U” bend in the preferred embodiment), whose height can be adjusted manually, e.g., by insertion of removable pipework spools or by using an appropriate flexible coupling or flexible hose. The function of the lute is to allow control of the liquid level in the condenser. Liquid solvent will in use accumulate in the vessel until the level rises to that of the high point in the lute. Thereafter the level will rise until the head above the lute's high point is sufficient to allow drainage of the solvent. This therefore provides an intrinsic control of the level in the condenser.

According to a second aspect of the invention there is provided a method of operating a condenser for a closed loop biomass extraction circuit. The condenser comprises a substantially closed vessel having a hollow interior including an upper portion and a lower portion. The hollow interior has secured therein one or more cooling members for condensing solvent, in vapour form, supplied to the hollow interior from an extractor of a biomass extraction circuit, the lower portion of the hollow interior being a reservoir, for condensed solvent, at or below at least one of said cooling member. The reservoir includes a liquid offtake for condensed solvent, wherein the offtake includes a pipe including an in-line lute and wherein the depth of the lute, as defined by the vertical height of the uppermost part of the lute, is adjustable. The method includes selectively adjusting said level while the condenser operates to condense vaporized solvent. Preferred features are embodied in a method wherein the step of selectively adjusting the depth results in control of the level of the liquid in the reservoir and/or control of the temperature of the liquid in the reservoir. As noted therein, the method may advantageously control the level of liquid in the reservoir with a view to avoiding the adverse effects of disturbances as noted herein above.

Another possibility is to use the method of the invention to control the temperature of the liquid in the reservoir.

A further possibility is to use the method of the invention to control the liquid level in the reservoir in order to maintain a preferred pressure difference between the condenser and evaporator.

According to a third aspect of the invention there is provided a condenser-reservoir assembly for a closed loop biomass extraction circuit wherein the assembly comprises, operatively connected in series, an inlet to a heat exchanger, for solvent vapour from the heat exchanger, for liquid solvent; a heat exchanger; an outlet from the heat exchanger, for liquid solvent; a liquid reservoir connected to the outlet; and an outlet.

The assembly advantageously extends the principle of the sub-cooling lute in the previously described preferred embodiment (1) above in which the heat exchanger and reservoir are discrete yet interconnected components (i.e., they are not parts of the same vessel).

Advantageous, optional features of the above-described condenser-reservoir assembly are described and claimed in International Application No. PCT/GB00/03351, previously incorporated by reference and are set forth below. One or more of the advantageous, optional features listed below may be combined with the above and embodied in: (1) an assembly according to the third aspect described above wherein an outlet from the reservoir is connected to the low point of the liquid lute, the low point lying generally below the heat exchanger; (2) an assembly according to the third aspect described above wherein an inlet to the reservoir is connected to the low point of the liquid lute; (3) an assembly according to the third aspect or any one of the embodiments (1) or (2) above including a drain for draining a reservoir; (4) an assembly according to the third aspect described above or any of the embodiments incorporating the same including a siphon breaking line fluidically interconnecting the high point of the liquid lute and the inlet to the heat exchanger; (5) an assembly according to embodiment (4) above wherein the siphon breaking line includes a resistance to flow; (6) an assembly according to the third aspect described above or any embodiment incorporating the same wherein the heat exchanger is a plate heat exchanger; (7) an assembly according to the third aspect described above or any embodiment incorporating the same wherein the lute includes one or more vertically extending pipe portions of a diameter large enough to permit vapour bubbles entrained in liquid flowing through the lute to rise in the lute and disengage therefrom; (8) an assembly according to embodiment (7) above wherein the lute includes an outlet pipe portion, connectable to a biomass extraction vessel or a solvent circulation pump and connected to a said vertically extending pipe portion, the diameter of the outlet portion being less the diameter of said vertically extending pipe portion, thereby ensuring that the outlet pipe portion remains full in use of the apparatus; (9) an assembly according to the third aspect described above or any embodiment incorporating the same wherein the depth of the lute, as defined by the vertical height of the uppermost port of the inverted lute, is adjustable; (10) an assembly according to embodiment (9) above wherein the said height of the uppermost part of the lute is adjustable by lengthening or shortening of one or more length-adjustable, vertically extending pipes interconnecting the lowermost and uppermost parts of the inverted lute; (11) an assembly according to embodiments (9) or (10) above wherein the lowermost and uppermost parts of the lute are interconnected by a flexible pipe to facilitate adjustment of the said depth; (12) an assembly according to the third aspect described above or any embodiment incorporating the same including a modulating control line, having an in-line adjustable control valve, the modulating control line operatively interconnecting an outlet from the reservoir and the outlet of the lute; (13) an assembly according to the embodiment (12) above including a detector for detecting a variable in use of the apparatus and operating the adjustable flow control valve in dependence on the detected value of the variable; (14) an assembly according to embodiment (13) above wherein the variable is selected from the pressure of solvent vapour fed to the heat exchanger; the temperature of fluid at a chosen location in the assembly; the difference between solvent pressure values at the low point of the lute and at the inlet to the heat exchanger.

According to a fourth aspect of the invention, there is provided a method of operating a condenser-reservoir assembly of the type described above. The method may be practiced in combination with one or more of the advantageous, optional features (1)-(14), also described above.

Further, advantageous features of the method are listed below. The advantageous features can be combined with the above to provide a method wherein the step of selectively adjusting the depth results in control of the temperature of liquid in the reservoir and/or including the step of operating the modulating control valve.

The control scheme used in preferred embodiments of the invention will be determined by the designer of the process according to preference and desired operating conditions. However the control of temperature, pressure and level may be beneficially optimised by use of a single control device, e.g., a microprocessor/PC, to adjust the level in conjunction with adjustment of the coolant flowrate to the condenser.

There now follows a description of preferred embodiments of the invention, by way of non-limiting example, with reference being made to the accompanying drawings.

### BRIEF DESCRIPTION OF THE SEVERAL VIEWS OF THE DRAWING(S)

FIG. 1 is a schematic representation of a prior art closed loop biomass extraction apparatus;

FIG. 2 is a schematic, cross-sectional view of a first embodiment of apparatus according to the invention;

FIG. 3 is a schematic, cross-sectional view of a second embodiment of apparatus according to the invention;

FIG. 4 is a schematic representation of a third embodiment of apparatus according to the invention; and

FIG. 5 shows a variant of the FIG. 4 arrangement.

### DETAILED DESCRIPTION OF THE INVENTION

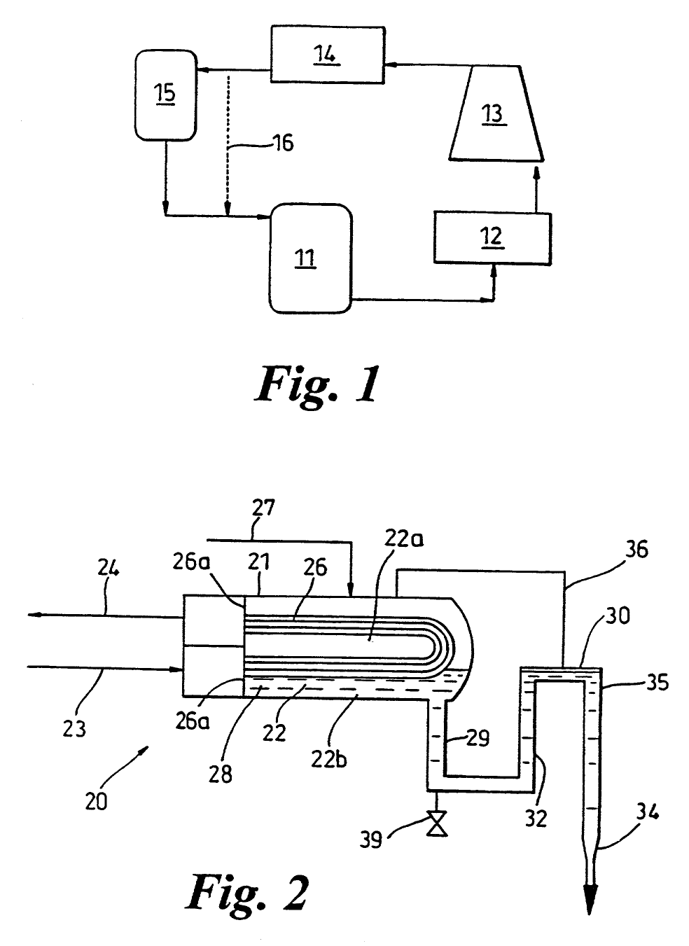

Referring to FIG. 2 there is shown a combined condenser and receiver 20 that may be incorporated into the FIG. 1 circuit in replacement of the condenser 14 and storage/receiver vessel 15.

Condenser/receiver 20 of FIG. 2 includes a substantially closed, generally horizontal, cylindrical vessel 21 having a hollow interior 22. Interior 22 may be considered as having an upper portion 22a and a lower portion 22b.

Supported within hollow interior 22 is a plurality of cooling members that in the preferred embodiment shown are a bundle of hollow, parallel u-tubes 26 each secured at one end 26a to a wall of the vessel 21. A coolant intake 23 feeds, e.g., liquid coolant into the lower branch of each u-tube through the end wall of vessel 21 in a per se known manner. The coolant may circulate through the u-tubes to exit from the respective u-tube upper branches via an outlet 24 that passes through the said end wall.

In use of the apparatus 20 the tubes 26 condense solvent supplied to the vessel in vapour form, e.g., from the evaporator 12 of the FIG. 1 apparatus, via vapour inlet line 27 that supplies the vapour through the wall of vessel upper zone 22a.

As shown, the lower portion 22b of hollow interior 22 is a reservoir for condensed, liquid solvent 28. The reservoir exists at or below the cooling members (u-tubes) 26.

The reservoir includes liquid offtake 29 for removing liquid coolant from the reservoir in lower portion 22b.

The offtake 29 is constituted as a pipe including an in-line, inverted lute 30 (in the form of a u-bend).

In the FIG. 2 arrangement the diameter of the vertical section 32 of lute 30 is chosen to be sufficiently large that any bubbles of vapour entrained into the lute can rise against the flow and disengage. A reducing section 34 in the vertical line is then used to bring the pipe diameter down to a size which guarantees that the line will run full from that point. This then ensures that no vapour can be swept forward into the extraction vessel 11 and associated pipework. The high point 35 of the lute is fitted with a siphon breaking line 36, connected back to the upper portion 22a of the vessel 21 (condenser shell). This prevents any “surging” of liquid out of the condenser 20 and helps maintain a steady pressure at the base of the lute's outflow pipe. The low point of the liquid offtake line is fitted with a valved drain connection 39 so that the contents of the shell 22 can be drained to a recovery vessel (not shown) at the end of the extraction cycle. An additional valved connection on the top of the shell (not shown) acts as a vapour balancing connection to facilitate this drainage. Optionally this can be by the same connector as used for the siphon breaker line.

The liquid flowing out of the lute system can be led directly to the extraction vessel 11 of FIG. 1.

The “height” (i.e., overall depth) of the lute 30 can be used to control the level of liquid in lower portion 22b. This can be achieved by making the lute height adjustable, e.g., by means of selectably insertable spools that vary the lengths of the vertical parts of the lute; or by means of a flexible pipe connection, e.g., in the pipework upstream of the lute, that allows the height of the lute portion 35 to be adjusted.

The lute 30 can also be used to provide control over the temperature of the liquid solvent. If the high point 35 of the lute is arranged so that it is above the bottom of the tube bundle 26, then a portion of the heat transfer area provided by bundle 26 will be unavailable for condensation. It can however be used for subcooling of the condensed liquid solvent 28 in zone 22b. This is especially attractive if the coolant being used undergoes sensible heating on passing through the condenser 20. In that case it is advantageous to arrange the geometry as shown in FIG. 2, with the cold fluid entering the base of the bundle at 23 (where it can subcool the condensate) and leaving from the top half of the bundle at 24. This arrangement can be accomplished using a “U-tube” as shown or “1-2” geometry (“1-2”=1 shell-side pass, 2 tube-side passes). Other suitable exchanger geometries can be applied according to the wish of the process design engineer.

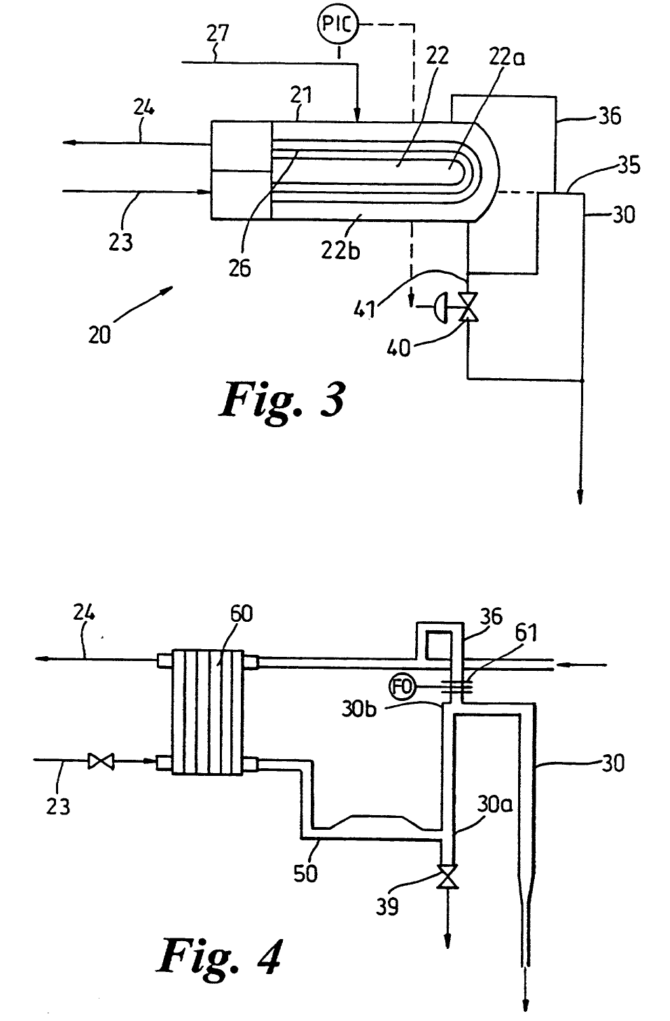

A further embodiment of apparatus according to the invention is shown in FIG. 3. This apparatus is similar to the FIG. 2 apparatus. Components of the FIG. 3 apparatus having a like function to those in FIG. 2 are identified by the same reference numerals in FIG. 3. In this case a combination of a modulating control valve 40 and a lute 30 is used. The lute may be the same as in FIG. 2.

The FIG. 3 arrangement provides facility to tune the holdup of liquid in the condenser 20 automatically, so that variation in level and subcool can be accomplished in the course of the extraction. In this case the normal condensed solvent flow path is through the valved line 41; the lute 30 acts as an overflow to guarantee that a desired maximum level is not exceeded in the shell (vessel) 22b.

In an alternative preferred embodiment of the invention, shown in FIG. 4, the condenser 60 and reservoir 50 are discrete yet fluidically interconnected components. The principle of control using the lute 30 may be applied to such an arrangement. Preferably the condenser 40 is a plate heat exchanger, optionally incorporating a luted drain 30 on the condenser liquid outlet line. In this embodiment an optional liquid volume 50 is included at the low point 30a of the luted drain to provide buffer capacity as required. In operation this volume will be flooded with liquid by virtue of its location. The presence of the buffer volume affords a convenient way of dampening fluctuations in solvent temperature by providing thermal mass. A valved drain line 39 connects the low point of this outlet line to the solvent receiver, which is isolated by, e.g., a valve during extraction and is used to capture solvent at the end of an extraction cycle.

The luted drain 30 is of adjustable height as in the FIGS. 2 and 3 embodiments. Preferably the high point 30b is fitted with a vapour balance line 36 as shown. This line is connected from the top of the pipework to the condenser inlet, optionally containing a restriction orifice fitting 61 as shown and preferably arranged so that the line drains naturally into the lute. The restriction orifice could if desired be replaced by another flow restriction such as (but not limited to) a non-return valve.

The restriction orifice allows insertion of a resistance to gas flow so as to ensure that the hot gas does not bypass the condenser to a significant extent.

The other components in FIG. 4 (i.e. the cooling fluid lines 23 and 24 for heat exchanger 40 and line size reduction 34) function in the same way as their counterparts in FIGS. 2 and 3.

In FIG. 4 the receiver vessel, such as vessel 15 of FIG. 1, which can be a standard solvent recovery vessel, is coupled to the condenser by isolatable drain line 39.

The advantages of using a plate heat exchanger for the condensation are: cost, size and ease of cleaning. To allow control of level and temperatures outlined above the principle of adjustable lute 30 can be used in an exactly analogous way to that described previously. If desired a small reservoir 50 can be incorporated at the low point of the lute as shown in FIG. 4.

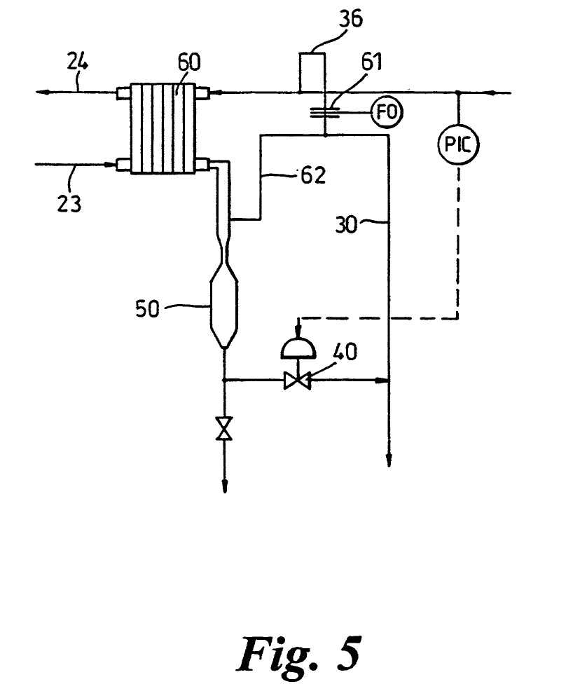

A derivation of this embodiment is shown in FIG. 5, which is analogous to the embodiment represented in FIG. 3. In this embodiment the level of liquid in the condenser is altered by the modulating control valve 40, which can be driven by, e.g., a pressure control loop as shown, or alternatively by control of an indicated temperature, or by measured pressure difference between the low point and the vapour inlet. A secondary inbed overflow 62 ensures that the condenser can drain even if the valve closes through, e.g., failure.

A small liquid buffer volume is provided by expansion of the vertical liquid outlet line and a low point drain connection to a solvent recovery vessel allows removal of the solvent from the system.

The remaining components of the FIG. 5 embodiment are analogous to their counterparts respectively in FIGS. 3 and 4.

The valve 40 in FIGS. 3 and 5 can be driven by e.g. a temperature controller acting in dependence on the solvent liquid temperature leaving the system, to guarantee a desired liquid temperature. It can alternatively be operated by a controller whose input is a measurement of the condenser pressure or differential pressure between the condenser 20/60 and evaporator 14. Control of the pressure will guarantee a near-constant liquid level and hence an implicit degree of subcooling, dependent on the geometry chosen for the condenser and lute 30. An advantage of using a pressure signal as an input is that it gives a rapid response to changes and thus provides fast-acting control, whereas a controller acting on the liquid temperature would take longer to respond because of the thermal mass of the solvent stored in the shell of the condenser. A per se known pressure instrument and controller, suitable for this purpose, is denoted schematically in FIGS. 3 and 5 by the symbol “PIC” and by the dotted control line.

In summary, the advantages of the invention include simple control of the distribution of inventory of solvent in a closed loop system; ability to combine solvent receiver with condenser

What is claimed:

1. A condenser for a closed loop biomass extraction circuit, the condenser comprising a substantially closed vessel having a hollow interior including an upper portion and a lower portion, the hollow interior having secured therein one or more cooling members for condensing solvent, in vapour form, supplied to the hollow interior from an extractor of a biomass extraction circuit, the lower portion of the hollow interior being a reservoir, for condensed solvent, at or below at least one said cooling member, the reservoir including a liquid offtake for condensed solvent.

2. A condenser according to claim 1, wherein the offtake includes a pipe including an in-line lute.

3. Apparatus according to claim 2, including a siphon breaking line fluidically interconnecting the uppermost part of the lute and the upper portion of the hollow interior of the vessel.

4. Apparatus according to claim 3, wherein the siphon breaking line includes a resistance to flow.

5. Apparatus according to claim 2, wherein the lute includes one or more vertically extending pipe portions of a diameter large enough to permit vapour bubbles entrained in liquid flowing through the lute to rise in the lute and disengage therefrom.

6. Apparatus according to claim 5, wherein the lute includes an outlet pipe portion, connectable to a biomass extraction vessel or a solvent circulation pump and connected to a said vertically extending pipe portion, the diameter of the outlet portion being less than the diameter of said vertically extending pipe portion, thereby ensuring that the outlet pipe portion remains full in use of the apparatus.

7. Apparatus according to claim 1, wherein the liquid offtake includes a selectively operable drain for draining liquid from the reservoir.

8. Apparatus according to claim 1, wherein the lower portion of the hollow interior includes a bottom wall that inclines downwardly towards the liquid offtake, whereby liquid condensate in the reservoir accumulates in the vicinity of the liquid offtake.

9. Apparatus according to claim 2, wherein the depth of the lute, as defined by the vertical height of the uppermost part of the inverted lute, is adjustable.

10. Apparatus according to claim 9 wherein the said depth is adjustable by lengthening or shortening of one or more length-adjustable, vertically extending pipes interconnecting the lowermost and uppermost parts of the inverted lute.

11. Apparatus according to claim 9, wherein the lowermost and uppermost parts of the lute are interconnected by a flexible pipe and/or connector to facilitate adjustment of the depth.

12. Apparatus according to claim 1, wherein the vessel includes a selectively operable vapour balancing vent for venting the upper portion of the hollow interior.

13. Apparatus according to claim 2, including a modulating control line (41), having in-line an adjustable flow control valve (40), the modulating control line operatively interconnecting the liquid offtake from the reservoir (22b) and the outlet of the lute (30).

14. Apparatus according to claim 13, including a temperature detector for generating a control signal in dependence on the temperature of liquid in the reservoir (22b), the adjustable flow control valve (40) being adjustable in dependence on the control signal.

15. Apparatus according to claim 13, including a pressure detector for generating a control signal in dependence on the pressure of liquid in the reservoir (22b; 60), the adjustable flow control valve (40) being adjustable in dependence on the control signal.

16. Apparatus according to claim 13, when operated in conjunction with an evaporator for evaporating solvent supplied to the vessel, the apparatus including a detector of differential pressure between the interior of the evaporator and the hollow interior of the vessel, the detector generating a control signal in dependence thereon and the adjustable flow control valve (40) being adjustable in dependence on the control signal.

17. Apparatus according to claim 1, wherein, in use, the level of liquid in the reservoir is controlled to be higher than at least part of a said cooling member, whereby the said cooling member cools liquid in the reservoir.

18. A method of operating a condenser for a closed loop biomass extraction circuit, the condenser comprising a substantially closed vessel having a hollow interior including an upper portion and a lower portion, the hollow interior having secured therein one or more cooling members for condensing solvent, in vapour form, supplied to the hollow interior from an extractor of a biomass extraction circuit, the lower portion of the hollow interior being a reservoir, for condensed solvent, at or below at least one said cooling member, the reservoir including a liquid offtake for condensed solvent, wherein the offtake includes an adjuster for adjusting the level of condensed solvent in the reservoir, the method including the step of selectively adjusting the said level while the condenser operates to condense vaporised solvent.

19. A method according to claim 18, wherein the step of selectively adjusting the depth results in control of the level of the liquid in the reservoir.

20. A method according to claim 18, wherein the step of selectively adjusting the depth results in control of the temperature of liquid in the reservoir.

21. A condenser-reservoir assembly for a closed loop biomass extraction circuit, the assembly comprising, operatively connected in series, an inlet to a heat exchanger (60), for solvent vapour from the heat exchanger, for liquid solvent;
a heat exchanger;
an outlet from the heat exchanger, for liquid solvent
a liquid reservoir connected to the outlet; and an outlet.

22. An assembly according to claim 21, wherein an outlet from the reservoir is connected to the low point of the liquid lute, the low point lying generally below the heat exchanger.

23. An assembly according to claim 21, wherein an inlet to the reservoir is connected to the low point of the liquid lute.

24. An assembly according to claim 21, including a drain for draining the reservoir.

25. An assembly according to claim 21, including a siphon breaking line fluidically interconnecting the high point of the liquid lute and the inlet to the heat exchanger.

26. An assembly according to claim 25, wherein the siphon breaking line includes a resistance to flow.

27. An assembly according to claim 21, wherein the heat exchanger is a plate heat exchanger.

28. An assembly according to claim 21, wherein the lute includes one or more vertically extending pipe portions of a diameter large enough to permit vapour bubbles entrained in liquid flowing through the lute to rise in the lute and disengage therefrom.

29. An assembly according to claim 28, wherein the lute includes an outlet pipe portion, connectable to a biomass extraction vessel or a solvent circulation pump and connected to a said vertically extending pipe portion, the diameter of the outlet portion being less the diameter of said vertically extending pipe portion, thereby ensuring that the outlet pipe portion remains full in use of the apparatus.

30. An assembly according to claim 21, wherein the depth of the lute, as defined by the vertical height of the uppermost part of the inverted lute, is adjustable.

31. An assembly according to claim 30, wherein the said is adjustable by lengthening or shortening of one or more length-adjustable, vertically extending pipes interconnecting the lowermost and uppermost parts of the inverted lute.

32. An assembly according to claim 30, wherein the lowermost and uppermost parts of the lute are interconnected by a flexible pipe to facilitate adjustment of the said depth.

33. An assembly according to claim 21, including a modulating control line, having an in-line adjustable control valve, the modulating control line operatively interconnecting an outlet from the reservoir and the outlet of the lute.

34. An assembly according to claim 33, including a detector for detecting a variable in use of the apparatus and operating the adjustable flow control valve in dependence on the detected value of the variable.

35. An assembly according to claim 34, wherein the variable is selected from:
the pressure of solvent vapour fed to the heat exchanger;
the temperature of fluid at a chosen location in the assembly;
